(19) United States
(12) Patent Application Publication
(10) Pub. No.: US 2019/0186406 A1
(43) Pub. Date: Jun. 20, 2019

(54) CONTROLLER FOR INTERNAL COMBUSTION ENGINE

(71) Applicant: TOYOTA JIDOSHA KABUSHIKI KAISHA, Toyota-shi (JP)

(72) Inventor: Kotaro SUZUKI, Ashigarakami-gun (JP)

(73) Assignee: TOYOTA JIDOSHA KABUSHIKI KAISHA, Toyota-shi (JP)

(21) Appl. No.: 16/198,455

(22) Filed: Nov. 21, 2018

(30) Foreign Application Priority Data
Dec. 20, 2017 (JP) 2017-244330

(51) Int. Cl. F02D 41/40

(52) U.S. Cl. CPC F02D 41/401; F02D 2041/389; F02D 2200/101

(57) ABSTRACT

A controller includes an injection control unit configured to set an injection start timing of fuel based on an engine speed to start injecting the fuel with a cylinder injection valve during an intake stroke. The injection start timing set by the injection control unit when the engine speed is equal to a specified engine speed is referred to as a specified timing. The injection control unit is configured to set the specified timing as the injection start timing or retard the injection start timing from the specified timing when the engine speed is in a range that is higher than the specified engine speed.

### BACKGROUND

The present invention relates to a controller for an internal combustion engine.

Japanese Laid-Open Patent Publication No. 3-33449 discloses a controller for an internal combustion engine that performs cylinder injection. The controller sets a fuel injection amount and an injection timing based on the speed of the internal combustion engine. More specifically, an injection end timing is set, and a timing advanced from the injection end timing by a period corresponding to the fuel injection amount is set as an injection start timing. The fuel injection amount is calculated to increase as the engine speed increases. Thus, the above controller advances the injection start timing as the engine speed increases.

In an intake stroke of the internal combustion engine, as the piston moves from the top dead center toward the bottom dead center, the movement speed of the piston increases as the piston moves away from the top dead center. Then, as the piston approaches the bottom dead center, the movement speed of the piston decreases. During the intake stroke, the speed of the flowrate of air in the combustion chamber increases as the movement speed of the piston increases. Further, a typical internal combustion engine performing cylinder injection injects fuel in an intake stroke or a compression stroke. Thus, when an injection start timing is advanced as the engine speed increases like in the above controller, the advanced injection start timing may result in fuel injection being performed when the piston is located near a midpoint position where the movement speed of the piston is high. If fuel injection is performed when the movement speed of the piston is high and the air flowrate is high in the combustion chamber, atomized fuel is likely to be carried by the airflow.

In particular, an internal combustion engine of a central injection type includes a cylinder injection valve and a spark plug arranged at the central portion of a combustion chamber wall that defines the combustion chamber on a cylinder head. Since the fuel injection valve and the spark plug are positioned close to each other in the central injection internal combustion engine, the atomized fuel carried by the airflow is likely to reach the periphery of the spark plug. When the atomized fuel reaches the periphery of the spark plug and vaporizes, the temperature of the spark plug decreases due to the latent heat of vaporization of the atomized fuel. This may reduce the durability of the spark plug.

### SUMMARY

A controller for an internal combustion engine according to one aspect is configured to control the internal combustion engine. The internal combustion engine includes a cylinder injection valve and a spark plug arranged at a central portion of a combustion chamber wall, which is one of combustion chamber walls defining a combustion chamber and which is provided on a cylinder head. The controller includes an injection control unit configured to set an injection start timing of fuel based on an engine speed to start injecting the fuel with the cylinder injection valve during an intake stroke. The injection start timing set by the injection control unit when the engine speed is equal to a specified engine speed is referred to as a specified timing. The injection control unit is configured to set the specified timing as the injection start timing or retard the injection start timing from the specified timing when the engine speed is higher than the specified engine speed.

In the intake stroke, when the piston moves from the top dead center toward the bottom dead center, the movement speed of the piston increases as the piston moves away from the top dead center. Then, the movement speed of the piston decreases as the piston approaches the bottom dead center. When the movement speed of the piston is high, the air flowrate in the combustion chamber is higher than when the movement speed is not high and the piston is located near the top dead center or the bottom dead center. Thus, if the cylinder injection valve injects fuel when the movement speed of the piston is high in the intake stroke, atomized fuel is likely to be carried toward the spark plug by the airflow in the combustion chamber. Further, the movement speed of the piston is high and the air flowrate in the combustion chamber is high when the engine speed is high.

With the above structure, if the engine speed is higher than a specified engine speed and the engine speed is determined to be high, the injection start timing is not advanced from the specified timing. In other words, if the engine speed is high, the injection start timing is less likely to be set to a period in which the movement speed of the piston is high. Thus, situations are reduced in which the atomized fuel is carried toward the spark plug by the airflow generated in the combustion chamber during the intake stroke. This reduces decreases in the temperature of the spark plug that is caused by vaporization of the atomized fuel in the periphery of the spark plug.

In one example of the above internal combustion engine controller, the injection control unit may be configured to set the injection start timing to be further retarded as the engine speed increases when the engine speed is in a range of engine speed that is higher than the specified engine speed.

If the engine speed is high, an average movement speed of the piston in the intake stroke is likely to be higher than when the engine speed is low. Thus, a period in which the movement speed of the piston is higher than the predetermined speed tends to be longer as the engine speed increases. If the movement speed of the piston is higher than the predetermined speed, the airflow generated in the combustion chamber is fast and atomized fuel is likely to be carried toward the spark plug by the airflow. In other words, as the engine speed increases, the atomized fuel is more likely to be carried toward the spark plug by the airflow generated in the combustion chamber during the intake stroke. In contrast, with the above structure, the injection start timing is set to be retarded as the engine speed increases. In other words, the injection start timing is less likely to be set to when the movement speed of the piston is high as the engine speed increases. This enhances the advantage of preventing the atomized fuel from being carried toward the periphery of the spark plug by the airflow generated in the combustion chamber.

In one example of the above internal combustion engine controller, the injection control unit may be configured to set the specified timing as the injection start timing when the engine speed is higher than the specified engine speed.

In one example of the above internal combustion engine controller, the injection control unit may be configured to set the injection start timing to be further advanced until the specified timing as the engine speed increases when the engine speed is lower than the specified engine speed.

A fuel injection amount of the cylinder injection valve is likely to be set to increase as the engine speed increases. Thus, as the engine speed increases, a period corresponding to the injection amount tends to be prolonged thereby retarding the injection end timing. In contrast, with the above structure, if the engine speed is lower than the specified engine speed, the injection start timing is set to be advanced as the engine speed increases. Thus, if the engine speed is lower than the specified engine speed, the injection end timing is less likely to be set to be retarded.

In one example of the above internal combustion engine controller, the injection control unit may be configured to set the specified timing as the injection start timing when the engine speed is lower than the specified engine speed.

In one example of the above internal combustion engine controller, the injection control unit may set an injection end timing based on the injection start timing and a fuel injection amount.

The injection amount is set based on the engine speed and an engine load. Thus, if the engine load is high, a relatively large injection amount may be set even if the engine speed is not that high. When the injection end timing is set and then the injection start timing is to be set based on the injection end timing and the injection amount, if a relatively large injection amount is set, the injection start timing is likely to be advanced. In contrast, with the above structure, the injection start timing is set before the injection end timing is set. Thus, the injection start timing is less likely to be set to when the movement speed of the piston is high in the intake stroke even if the injection amount is large.

When the above internal combustion engine controller is applied to an internal combustion engine that uses alcohol-blended fuel, the injection control unit may be configured to set the injection start timing to be further retarded as alcohol concentration in injected fuel increases.

The latent heat of vaporization of fuel increases as the alcohol concentration increases in the blended fuel. If the fuel with a high alcohol concentration is drawn to the periphery of the spark plug and vaporized, the temperature of the spark plug is likely to decrease greatly due to the latent heat of vaporization of the fuel. However, with the above structure, the injection start timing is set to be retarded as the alcohol concentration of the fuel increases. Thus, when fuel with a great latent heat of vaporization is used, the injection start timing is prevented from being set to when the movement speed of the piston is high. This prevents the fuel with a large latent heat of vaporization from being drawn to the periphery of the spark plug and vaporized in the periphery of the spark plug.

Other aspects and advantages of the present disclosure will become apparent from the following description, taken in conjunction with the accompanying drawings, illustrating exemplary embodiments.

### BRIEF DESCRIPTION OF THE DRAWINGS

The disclosure may be understood by reference to the following description together with the accompanying drawings:

FIG. 1 is a schematic view showing a first embodiment of an internal combustion engine controller and an internal combustion engine subject to control of the controller;

FIG. 2 is a flowchart of fuel injection control performed by the controller according to the embodiment;

FIG. 3 is a map showing the relationship between an injection start timing and the engine speed set by the controller according to the embodiment;

FIG. 4 is a map showing the relationship between the injection start timing and the engine speed set by the controller in a comparative example;

FIG. 5 is a map showing the temperature change of a spark plug after fuel injection starts;

FIG. 6 is a map showing the relationship between an injection start timing and the engine speed set by a controller for an internal combustion engine according to a second embodiment;

FIG. 7 is a map showing the relationship between the injection start timing and the engine speed set by the controller for the internal combustion engine according to a third embodiment;

FIG. 8 is a map showing the relationship between the injection start timing and the engine speed set by the controller for the internal combustion engine according to a fourth embodiment; and

FIG. 9 is a map showing the relationship between a retardation correction amount and alcohol concentration that are used to calculate an injection start timing with a modification of an internal combustion engine controller.

### DETAILED DESCRIPTION

### First Embodiment

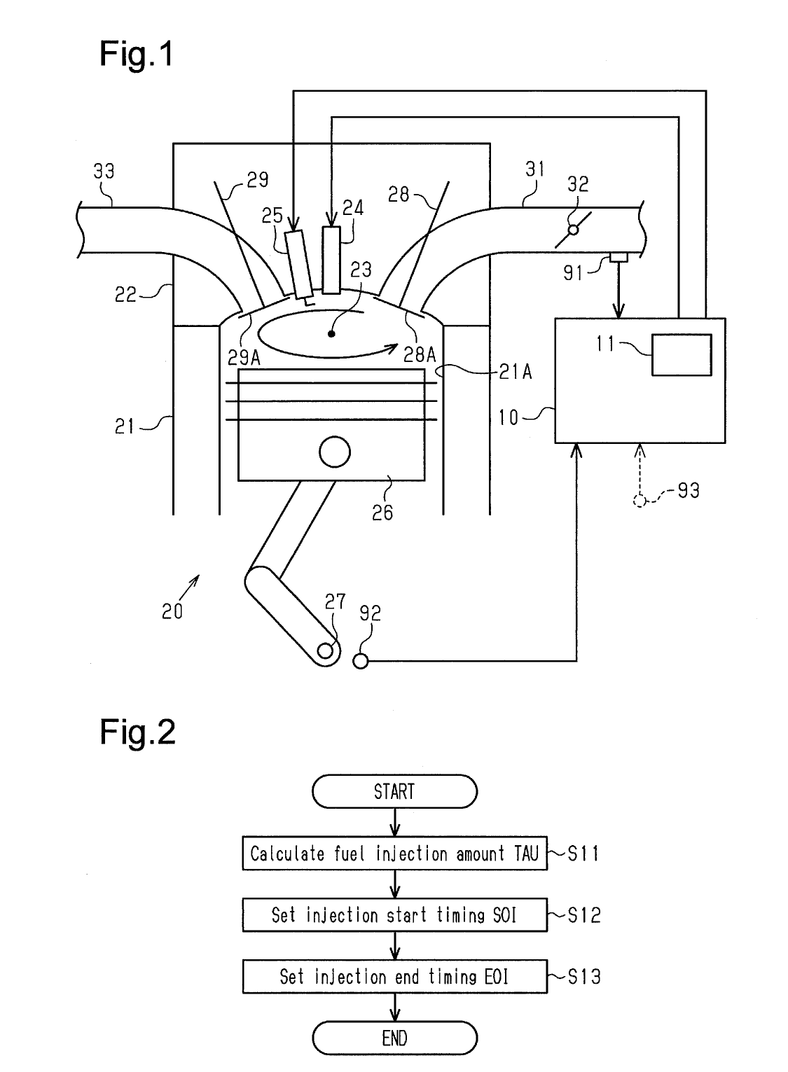

A controller 10 according to a first embodiment, which is an internal combustion engine controller, will now be described with reference to FIGS. 1 to 5.

FIG. 1 shows the controller 10 and an internal combustion engine 20 controlled by the controller 10. That is, the controller 10 is configured to control the internal combustion engine 20.

The internal combustion engine 20 includes a combustion chamber 23 defined by a cylinder block 21, a cylinder head 22, and a piston 26 arranged in a cylinder 21A of the cylinder block 21. When the piston 26 reciprocates in the cylinder 21A, a crankshaft 27, which is the driving shaft of the internal combustion engine 20, rotates in cooperation with the reciprocation of the piston 26. The combustion chamber 23 is connected to an intake passage 31 through which intake air is drawn into the combustion chamber 23, and an exhaust passage 33 through into which exhaust gas is discharged from the combustion chamber 23. When intake air is drawn from the intake passage 31 into the combustion chamber 23, an airflow, namely, a tumble flow, is generated in the combustion chamber 23 as shown by the arrow in FIG. 1.

A throttle valve 32 is arranged inside the intake passage 31. An airflow meter 91 that detects an intake air amount flowing through the intake passage 31 is arranged at an upstream side of the throttle valve 32 inside the intake passage 31.

The internal combustion engine 20 includes an intake valve 28. An umbrella 28A of the intake valve 28 opens and closes the intake passage 31 to the combustion chamber 23. The internal combustion engine 20 also includes an exhaust valve 29. An umbrella 29A of the exhaust valve 29 opens and closes the exhaust passage 33 from the combustion chamber 23.

The internal combustion engine 20 is an internal combustion engine of a central injection type. In one of the combustion chamber walls that defines the combustion chamber 23, a cylinder injection valve 24 and a spark plug 25 are arranged at the central portion of the combustion chamber wall of the cylinder head 22, that is, between the umbrella 28A of the intake valve 28 and the umbrella 29A of the exhaust valve 29. The spark plug 25 is arranged closer to the umbrella 29A of the exhaust valve 29 than the cylinder injection valve 24, that is, at a downstream side with respect to the direction of an airflow shown by the arrow in FIG. 1.

Detection signals from various sensors of the internal combustion engine 20 are input to the controller 10.

The controller 10 is configured to calculate an engine speed NE based on a detection signal from a crank position sensor 92. The controller 10 is also configured to detect the rotation angle of the crankshaft 27 based on a detection signal from the crank position sensor 92. In the present embodiment, with respect to the rotation angle, the rotation angle of the crankshaft 27 when the piston 26 is positioned at the compression top dead center TDC is referred to as a reference angle of “0° C.A.” Further, a crank angle BTDC is indicated as a positive value when the rotation angle of the crankshaft 27 is advanced from the reference angle.

The controller 10 calculates an intake air amount GA based on a detection signal from the airflow meter 91.

The controller 10 includes an injection control unit 11 serving as a function unit configured to control the cylinder injection valve 24. When the cylinder injection valve 24 injects fuel, the injection control unit 11 performs an injection setting process to set an injection amount TAU, an injection start timing SOI, and an injection end timing EOI. The injection control unit 11 is also configured to control the cylinder injection valve 24 and inject fuel based on the set injection amount TAU, injection start timing SOI, and injection end timing EOI.

A processing routine of the injection setting process performed by the injection control unit 11 will now be described with reference to FIG. 2. This routine is repeatedly performed in predetermined cycles as long as the controller 10 allows fuel injection.

When the processing routine starts, in step S11, the injection control unit 11 calculates a fuel injection amount TAU. The fuel injection amount TAU is calculated as the total amount of fuel injected in a single fuel injection. The fuel injection amount TAU is calculated based on the engine speed NE and the intake air amount GA. After the fuel injection amount TAU is calculated, the process proceeds to step S12.

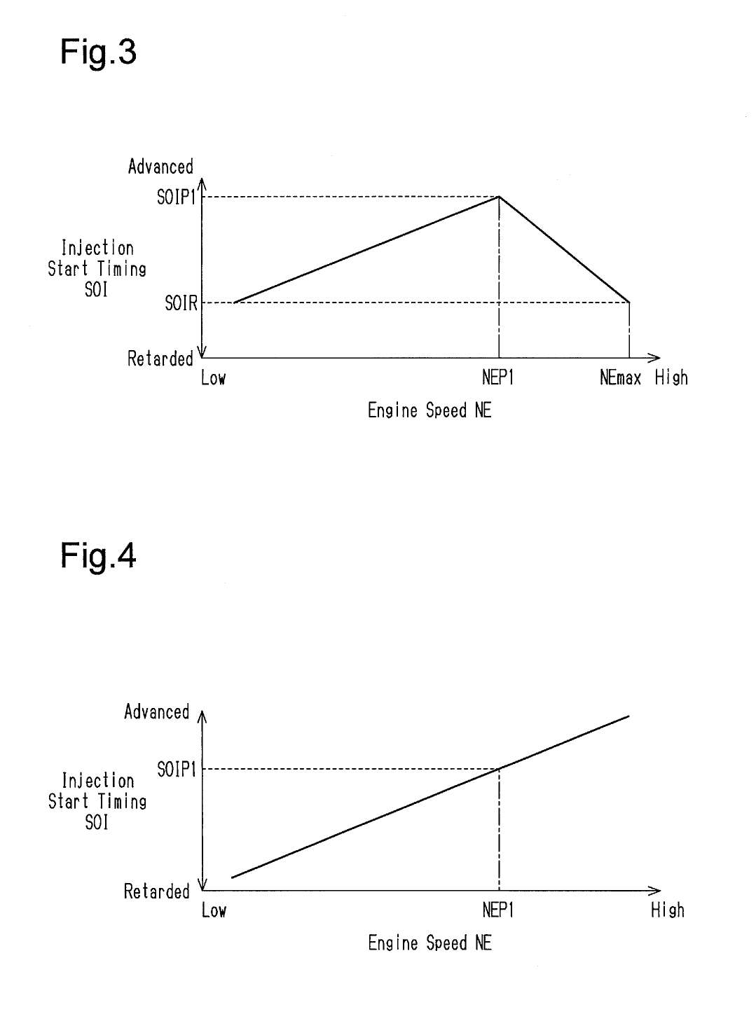

In step S12, the injection control unit 11 sets the injection start timing SOI. The injection control unit 11 obtains the engine speed NE and obtains the injection start timing SOI from a map that shows the relationship between the engine speed NE and the injection start timing SOI. The map is stored in the injection control unit 11. The map shown in FIG. 3 is used.

In the map shown in FIG. 3, if the engine speed NE is lower than a first specified engine speed NEP1, the injection start timing SOI is set to be advanced as the engine speed NE increases. If the engine speed NE is equal to the first specified engine speed NEP1, a first specified timing SOIP1 is set as the injection start timing SOI.

In contrast, if the engine speed NE is higher than the first specified engine speed NEP1, the injection start timing SOI is set to be retarded from the first specified timing SOIP1. Specifically, the injection start timing SOI is set to be further retarded as the engine speed NE increases. Further, if the engine speed NE at the maximum output of the internal combustion engine 20 is defined as the maximum engine speed NEmax, when the engine speed NE is equal to the maximum engine speed NEmax, a maximum engine speed injection timing SOIR is set as the injection start timing SOI. The maximum engine speed injection timing SOIR is determined in advance through experiments to be the most retarded timing tolerated as the injection start timing SOI when the engine speed NE is higher than the first specified engine speed NEP1.

Returning to FIG. 2, when the injection start timing SOI has been set in step S12, the process proceeds to step S13.

In step S13, the injection control unit 11 sets the injection end timing EOI based on the injection start timing SOI set in step S12 and the fuel injection amount TAU set in step S11. The injection end timing EOI is set as a timing retarded from the injection start timing SOI by a period corresponding to the injection amount TAU. The period corresponding to the injection amount TAU becomes longer as the injection amount TAU increases. In the present embodiment, the injection control unit 11 allows the injection end timing EOI to be set to be retarded from the intake bottom dead center such that fuel injection can be continuously performed in the compression stroke.

When the injection end timing EOI is set in step S13, the processing routine ends.

As mentioned above, with the controller 10, if the engine speed NE is higher than the first specified engine speed NEP1 when the injection control unit 11 performs the injection setting process, the injection start timing SOI is set to be retarded from the first specified timing SOIP1. Specifically, if the engine speed NE is higher than the first specified engine speed NEP1, the injection start timing SOI is set to be further retarded as the engine speed NE increases. Further, if the engine speed NE is lower than the first specified engine speed NEP1, the injection start timing SOI is set to be advanced as the engine speed NE increases until the first specified timing SOIP1.

The operation and advantages of the present embodiment will now be described.

An internal combustion engine controller in a comparative example will now be described with reference to FIG. 4. FIG. 4 is a map showing the relationship between the injection start timing SOI and the engine speed NE used by the controller in the comparative example. The controller in the comparative example sets the injection start timing SOI using the map show in FIG. 4. In the map shown in FIG. 4, the injection start timing SOI is set to advance as the engine speed NE increases. If the engine speed NE is equal to the first specified engine speed NEP1, the first specified timing SOIP1 is set as the injection start timing SOI in the same manner as the controller 10 sets the injection start timing SOI using the map shown in FIG. 3.

With the controller 10, as described with reference to FIG. 3, the injection start timing SOI is set to be further retarded from the first specified timing SOIP1 if the engine speed NE is higher than the first specified engine speed NEP1. In contrast, with the controller in the comparative example, as shown in FIG. 4, the injection start timing SOI is set to be further advanced from the first specified timing SOIP1 if the engine speed NE is higher than the first specified engine speed NEP1. The controller in the comparative example differs from the controller 10 only in the map used to set the injection start timing SOI. The controller in the comparative example is the same as the controller 10 in other structures.

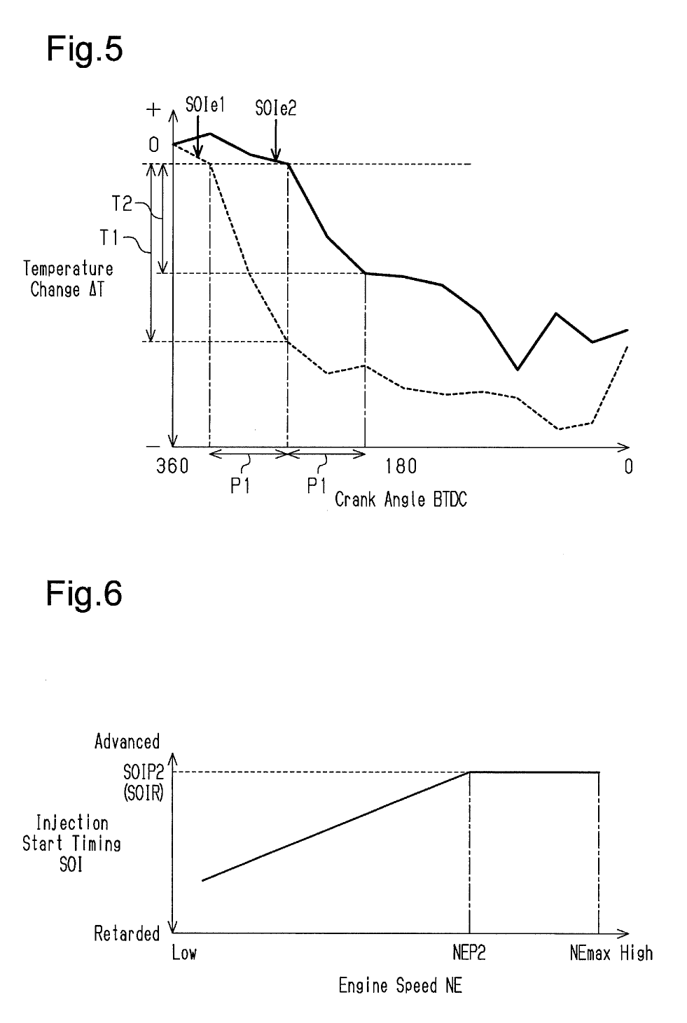

FIG. 5 exemplifies the temperature of the spark plug 25 that changes as the internal combustion engine 20 runs. The horizontal axis of FIG. 5 shows the crank angle BTDC. The vertical axis of FIG. 5 shows a temperature change amount ΔT that depicts the amount of change in temperature of the spark plug 25 from when the crank angle BTDC is 360° C.A. The temperature change amount ΔT in the case of the controller 10 is shown by solid lines, and the temperature change amount ΔT in the case of the controller in the comparative example is shown by dashed lines. In the example shown in FIG. 5, the engine speed NE is maintained at a predetermined value that is higher than the first specified engine speed NEP1. The load on the internal combustion engine 20 is constant.

In FIG. 5, the injection start timing SOI set by the controller in the comparative example is indicated as an injection start timing SOIe1, and the injection start timing SOI set by the controller 10 is indicated as an injection start timing SOIe2. The engine speed NE is higher than the first specified engine speed NEP1. Thus, the injection start timing SOIe1 in the comparative example is set to be advanced from the injection start timing SOIe2 in the present embodiment as shown in FIGS. 3 and 4.

As shown by the solid lines and the dashed lines in FIG. 5, the temperature of the spark plug 25 decreases after fuel injection starts. This is because in the case of the internal combustion engine 20 of the central injection type as shown in FIG. 1, the spark plug 25 and the cylinder injection valve 24 are positioned close to each other, and the spark plug 25 is arranged closer to the exhaust valve 29 than the cylinder injection valve 24. In other words, in the internal combustion engine 20, when intake air enters the combustion chamber 23 from the intake passage 31 in the intake stroke, the intake air that has entered the combustion chamber 23 moves toward the umbrella 29A of the exhaust valve 29. As a result, a tumble flow is generated in the combustion chamber 23 as shown by the arrow in FIG. 1. Since the spark plug 25 and the cylinder injection valve 24 have the above positional relationship, atomized fuel injected from the cylinder injection valve 24 is carried by the tumble flow, which is generated in the combustion chamber 23, to the periphery of the spark plug 25. When the atomized fuel vaporizes in the periphery of the spark plug 25, the temperature of the spark plug 25 is decreased by the latent heat of vaporization of the atomized fuel.

The temperature change amount ΔT of each set injection start timing (namely, the injection start timing SOIe1 and the injection start timing SOIe2) subsequent to fuel injection after a predetermined period P1 from when the temperature of the spark plug 25 begins to decrease will now be compared. As shown in FIG. 5, a decrease amount T1 in the case of the comparative example shown by the dashed lines is larger than a decrease amount T2 in the case of the present embodiment shown by the solid lines. In other words, the present embodiment decreases at a smaller rate over time than the comparative example.

The cause of the difference between the temperature change amounts ΔT will now be described. If the cylinder injection valve 24 injects fuel such that a period in which the fuel injection rate is the maximum value overlaps with a period in which the movement speed of the piston 26 is the maximum in the intake stroke, that is, a period in which the flowrate of the airflow generated in the combustion chamber 23 is high, the airflow generated in the combustion chamber 23 carries much of atomized fuel toward the spark plug 25. When a large amount of the atomized fuel is carried toward the spark plug 25 in this manner, the amount of the atomized fuel that vaporizes in the periphery of the spark plug 25 increases. This greatly decreases the temperature of the spark plug 25. The fuel injection rate of the cylinder injection valve 24 is not constant in an injection period corresponding to the fuel injection amount TAU and increases from the injection start timing SOI for injection start until reaching the maximum value of the fuel injection rate. The rate of fuel injection is maintained at the maximum value as the injection amount TAU increases. The fuel injection rate decreases from the maximum value such that the injection amount TAU ends at the injection end timing EOI.

With the controller of the comparative example, the injection start timing SOI is advanced as the engine speed NE increases, and the injection start timing SOI is likely to be further advanced from the period in which the movement speed of the piston 26 becomes the maximum. In other words, the period in which the fuel injection rate is the maximum value is likely to overlap with the period in which the movement speed of the piston 26 is high and the airflow is fast in the intake stroke. This increases the amount of atomized fuel that is carried by an airflow toward the spark plug 25 and vaporized in the periphery of the spark plug 25. Thus, the temperature of the spark plug 25 tends to decrease.

In contrast, with the controller 10 according to the present embodiment, if the engine speed NE is higher than the first specified engine speed NEP1, the injection start timing SOI is retarded as the engine speed NE increases. Thus, if the engine speed NE is higher than the first specified engine speed NEP1, the injection start timing SOI is not advanced from the first specified timing SOIP1. In other words, the injection start timing SOI is less likely to be set to be further advanced from the period in which the movement speed of the piston 26 becomes the maximum. This prevents the period in which the fuel injection rate has the maximum value from overlapping with the period in which the movement speed of the piston 26 is high and the airflow is fast in the intake stroke. As a result, in comparison with the controller in the comparative example, the amount of atomized fuel carried by the airflow toward the spark plug 25 is likely to decrease and the amount of atomized fuel that vaporizes in the periphery of the spark plug 25 is likely to decrease. This limits decreases in the temperature of the spark plug 25 compared with the controller of the comparative example.

As described above, with the controller 10, if the engine speed NE is high, the injection start timing SOI is less likely to be set to a period in which the movement speed of the piston 26 is high and the airflow generated in the combustion chamber 23 is fast. Thus, atomized fuel is prevented from being carried toward the spark plug 25 by the airflow generated in the combustion chamber 23 in the intake stroke. This reduces decreases in the temperature of the spark plug 25 that results from the vaporization of the atomized fuel in the periphery of the spark plug 25.

If the engine speed NE is high, the average movement speed of the piston 26 in the intake stroke is likely to be higher than when the engine speed NE is low. Thus, a period in which the movement speed of the piston 26 is higher than the predetermined speed tends to be longer as the engine speed NE increases. In the period in which the movement speed of the piston 26 is higher than the predetermined speed, the airflow generated in the combustion chamber 23 is fast and atomized fuel is likely to be carried toward the spark plug 25 by the airflow. In other words, as the engine speed NE increases, the atomized fuel is more likely to be carried toward the spark plug 25 by the airflow generated in the combustion chamber 23 in the intake stroke. In contrast, with the controller 10, if the engine speed NE is higher than the first specified engine speed NEP1, the injection start timing SOI is set to be further retarded as the engine speed NE increases. In other words, even if the period in which the movement speed of the piston 26 is higher than the predetermined speed is long because of the high engine speed NE, the injection start timing SOI is less likely to be set to a period in which the movement speed of the piston 26 is high and the airflow generated in the combustion chamber 23 is fast. This enhances the effect for reducing the atomized fuel carried toward the periphery of the spark plug 25 by the airflow generated in the combustion chamber 23.

Further, with the controller 10, the injection start timing SOI is set and then the injection end timing EOI is set based on the injection start timing SOI and the fuel injection amount TAU. This limits overlapping of the period in which the fuel injection rate has the maximum value with the period in which the movement speed of the piston 26 is high and the airflow is fast in the intake stroke even if the fuel injection amount TAU is relatively large.

If the engine speed NE is higher than the first specified engine speed NEP1, the injection amount TAU is relatively large because of the high engine speed NE, and the injection end timing EOI is likely to be set in the compression stroke. In contrast, with the controller 10, when the engine speed NE is equal to the maximum engine speed NEmax, the maximum engine speed injection timing SOIR, which is the most retarded timing tolerated as the injection start timing SOI when the engine speed NE is higher than the first specified engine speed NEP1, is set as the injection start timing SOI. Thus, if the engine speed NE is higher than the first specified engine speed NEP1, the injection start timing SOI is not further retarded from the maximum engine speed injection timing SOIR. This allows the injection end timing EOI to be less likely to be set in the compression stroke. Further, even if the injection end timing EOI is set in the compression stroke, the amount of fuel injected in the compression stroke can be decreased. In other words, since decreases are limited in the amount of fuel injected in the intake stroke, a sufficient amount of fuel is vaporized in the intake stroke. This decreases the temperature in the combustion chamber 23 with the latent heat of vaporization of the fuel injected in the intake stroke and improves the charging efficiency of intake air.

Further, with the controller 10, if the engine speed NE is lower than the first specified engine speed NEP1, the injection start timing SOI is set to be advanced as the engine speed NE increases. In other words, the injection start timing SOI is set to be advanced as the engine speed NE and the fuel injection amount TAU increase. Thus, if the engine speed NE is low and the maximum value of the movement speed of the piston 26 is not high, the injection period corresponding to the injection amount TAU is obtained so that fuel injection ends in the intake stroke.

### Second Embodiment

A second embodiment will now be described. The second embodiment differs from the first embodiment in that the second embodiment sets the injection start timing SOI with the map shown in FIG. 6 instead of the map shown in FIG. 3 in step S12 of the injection setting process illustrated in FIG. 2. Otherwise, the second embodiment is the same as the first embodiment, and the description will focus on the differences.

In the map shown in FIG. 6, if the engine speed NE is lower than a second specified engine speed NEP2, the injection start timing SOI is set to be advanced as the engine speed NE increases. If the engine speed NE is equal to the second specified engine speed NEP2, a second specified timing SOIP2 is set as the injection start timing SOI. If the engine speed NE is higher than the second specified engine speed NEP2, the second specified timing SOIP2 is also set as the injection start timing SOI.

If the engine speed NE is the maximum engine speed NEmax, the maximum engine speed injection timing SOIR, which is the same value as the maximum engine speed injection timing SOIR in the first embodiment, is set as the injection start timing SOI. If the engine speed NE is higher than the second specified engine speed NEP2, the second specified timing SOIP2 is set as the injection start timing SOI so that the second specified timing SOIP2 is the maximum engine speed injection timing SOIR. Thus, the second specified timing SOIP2 is retarded from the first specified timing SOIP1.

In other words, in the present embodiment, if the engine speed NE is higher than the second specified engine speed NEP2 when the injection control unit 11 performs the injection setting process, the second specified timing SOIP2 is set as the injection start timing SOI. Further, if the engine speed NE is lower than the second specified engine speed NEP2, the injection start timing SOI is set to be further advanced as the engine speed NE increases until the second specified timing SOIP2.

The operation and advantages of the present embodiment will now be described.

If the engine speed NE is higher than the second specified engine speed NEP2, the injection start timing SOI is not set to be advanced from the second specified timing SOIP2. This limits overlapping of the period in which the fuel injection rate is the maximum value from overlapping with the period in which the movement speed of the piston 26 is high and the airflow is fast during the intake stroke in the same manner as the first embodiment. Thus, the amount of atomized fuel carried by the airflow generated in the combustion chamber 23 toward the spark plug 25 decreases and the amount of atomized fuel that vaporizes in the periphery of the spark plug 25 decreases. This reduces decreases in the temperature of the spark plug 25.

### Third Embodiment

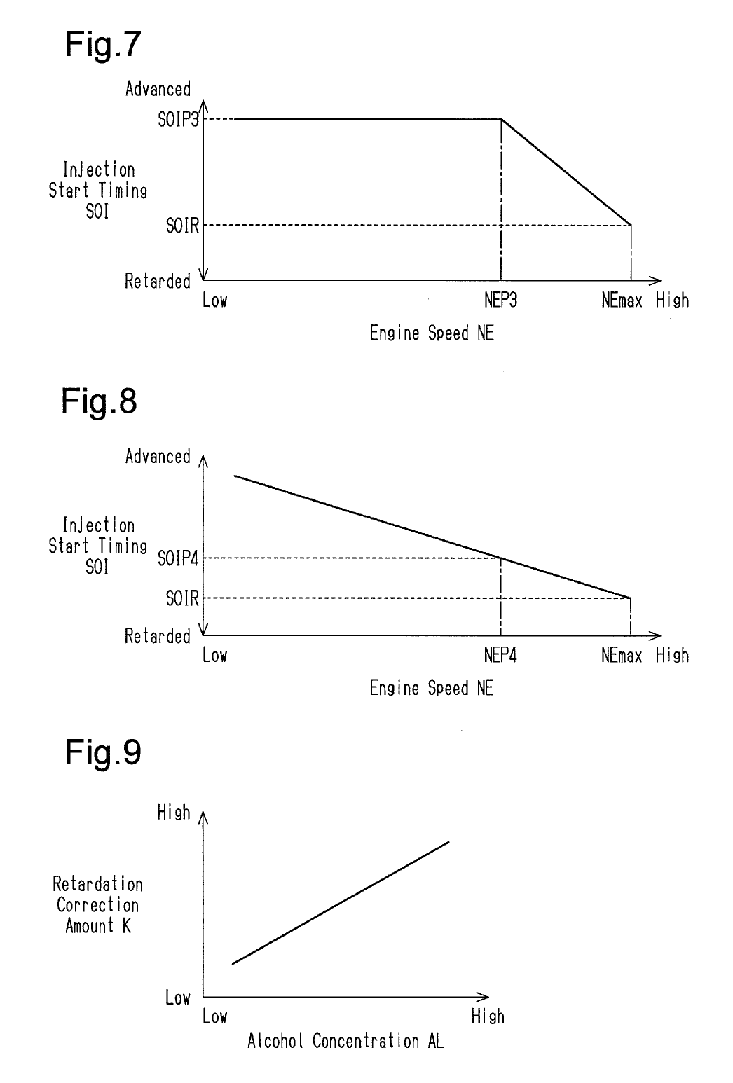

A third embodiment will now be described. The third embodiment differs from the first embodiment and the second embodiment in that the third embodiment sets the injection start timing SOI with the map shown in FIG. 7 in step S12 of the injection setting process described with reference to FIG. 2. Otherwise, the third embodiment is the same as the first embodiment and the second embodiment, and the description will focus on the differences.

In the map shown in FIG. 7, if the engine speed NE is lower than a third specified engine speed NEP3 or if the engine speed NE is equal to the third specified engine speed NEP3, a third specified timing SOIP3 is set as the injection start timing SOI. If the engine speed NE is higher than the third specified engine speed NEP3, the injection start timing SOI is set to be further retarded as the engine speed NE increases.

Further, the maximum engine speed injection timing SOIR set as the injection start timing SOI when the engine speed NE is the maximum engine speed NEmax is the same value as the maximum engine speed injection timing SOIR in the first embodiment and the second embodiment. The third specified timing SOIP3 is advanced from the maximum engine speed injection timing SOIR. Thus, the third specified timing SOIP3 is advanced from the second specified timing SOIP2.

In other words, in the present embodiment, if the engine speed NE is lower than the third specified engine speed NEP3 when the injection control unit 11 performs the injection setting process, the third specified timing SOIP3 is set as the injection start timing SOI. Further, if the engine speed NE is higher than the third specified engine speed NEP3, the injection start timing SOI is set to be retarded from the third specified timing SOIP3. More specifically, the injection start timing SOI is set to be further retarded as the engine speed NE increases.

The operation and advantages of the present embodiment will now be described.

If the engine speed NE is lower than the third specified engine speed NEP3 or if the engine speed NE is equal to the third specified engine speed NEP3, the injection start timing SOI is maintained as the third specified timing SOIP3. If the engine speed NE is higher than the third specified engine speed NEP3, the injection start timing SOI is set to be retarded from the third specified timing SOIP3. In other words, the injection start timing SOI is not advanced from the third specified timing SOIP3 in any range of the engine speed. Thus, if the engine speed NE is high, the injection start timing SOI is less likely to be set to a period in which the movement speed of the piston 26 is high and the airflow generated in the combustion chamber 23 is fast. Thus, atomized fuel is prevented from being carried toward the spark plug 25 by the airflow generated in the combustion chamber 23 in the intake stroke. This reduces the amount of atomized fuel that vaporizes in the periphery of the spark plug 25 and thereby limits decreases in the temperature of the spark plug 25.

### Fourth Embodiment

A fourth embodiment will now be described. The fourth embodiment differs from the first to third embodiments in that the fourth embodiment sets the injection start timing SOI with the map shown in FIG. 8 in step S12 of the injection setting process described with reference to FIG. 2. Otherwise, the fourth embodiment is the same as the first to third embodiments, and the description will focus on the differences.

In the map shown in FIG. 8, the injection start timing SOI is set to be further retarded as the engine speed NE increases regardless of the value of the engine speed NE. If the engine speed NE is equal to a fourth specified engine speed NEP4, a fourth specified timing SOIP4 is set as the injection start timing SOI. The maximum engine speed injection timing SOIR set as the injection start timing SOI when the engine speed NE is the maximum engine speed NEmax is the same value as the maximum engine speed injection timing SOIR in the first to third embodiments. The fourth specified timing SOIP4 is advanced from the maximum engine speed injection timing SOIR. Thus, the fourth specified timing SOIP4 is advanced from the second specified timing SOIP2.

In other words, in the present embodiment, if the engine speed NE is higher than the fourth specified engine speed NEP4 when the injection control unit 11 performs the injection setting process, the injection start timing SOI is set to be retarded from the fourth specified timing SOIP4. Further, if the engine speed NE is higher than the fourth specified engine speed NEP4, the injection start timing SOI is set to be further retarded as the engine speed NE increases. Further, if the engine speed NE is lower than the fourth specified engine speed NEP4, the injection start timing SOI is also set to be further retarded as the engine speed NE increases.

The operation and advantages of the present embodiment will now be described.

The injection start timing SOI is set to be further retarded as the engine speed NE increases regardless of the value of the engine speed NE. Thus, if the engine speed NE is higher than the fourth specified engine speed NEP4, the injection start timing SOI is set to be further retarded as the engine speed NE increases. This limits overlapping of the period in which the fuel injection rate is the maximum value with the period in which the movement speed of the piston 26 is the maximum in the intake stroke in the same manner as the first embodiment. As a result, if the engine speed NE is high, the injection start timing SOI is less likely to be set to a period in which the movement speed of the piston 26 is high and the airflow generated in the combustion chamber 23 is fast. This reduces the atomized fuel carried toward the spark plug 25 by the airflow generated in the combustion chamber 23 in the intake stroke. Thus, the amount of atomized fuel vaporized in the periphery of the spark plug 25 is reduced, and decreases in the temperature of the spark plug 25 are limited.

The following elements may be modified in each of the above embodiments. The above embodiments and the following modifications may be implemented in combination as long as there are no technical contradictions.

If the control subject of the controller 10 is an internal combustion engine that uses alcohol-blended fuel, the injection start timing SOI may be corrected based on the alcohol concentration AL of the injected fuel injected. In this case, as shown by the dashed line in FIG. 1, the controller 10 may detect the alcohol concentration AL of fuel based on a detection signal input by an alcohol concentration sensor 93 to the controller 10. Further, the alcohol concentration AL is not necessarily detected by the alcohol concentration sensor 93 but may be estimated by the controller 10. For example, the controller 10 may estimate the alcohol concentration AL based on a change of the air-fuel ratio of exhaust gas.

The following process may be employed to correct the injection start timing SOI. An injection start timing SOI obtained with the map shown in FIG. 3, 6, 7, or 8 is set as a basic start timing SIOB. Then, a value retarded by a retardation correction amount K from the basic start timing SIOB is set as an injection start timing SOI.

FIG. 9 is a map showing the relationship of the alcohol concentration AL and the retardation correction amount K. By obtaining the retardation correction amount K with the map, the retardation correction amount K increases as the alcohol concentration AL increases. In other words, the injection start timing SOI is set to be further retarded as the alcohol concentration AL increases.

Since the latent heat of vaporization of fuel increases as the alcohol concentration of blended fuel increases, if fuel with a high alcohol concentration AL is drawn to the periphery of the spark plug 25 and vaporized, the temperature of the spark plug 25 is likely to decrease greatly due to the latent heat of vaporization of the fuel. However, if fuel with a large latent heat of vaporization is used, the correction of the injection start timing SOI based on the alcohol concentration AL as described above enhances the advantage of preventing the injection start timing SOI from being set to a period in which the movement speed of the piston 26 is high and an airflow generated in the combustion chamber 23 is fast. In other words, the fuel with a large latent heat of vaporization is prevented from being drawn to the periphery of the spark plug 25.

The injection control unit 11 in the above embodiments sets the injection start timing SOI with the same map that defines the relationship between the engine speed NE and the injection start timing SOI in all the ranges of the engine speed indicating the engine speed NE. Alternatively, the injection control unit 11 may select and switch to any one of the maps where necessary based on the engine speed NE.

The following structure may be employed, for example. A first map is used if the engine speed NE is within a range from a value lower than a specified engine speed to a value equal to the specified engine speed. Based on the first map, the injection start timing SOI is set to be advanced as the engine speed NE increases. A second map that defines a relationship differing from the first map is used if the engine speed NE is higher than the specified engine speed. Based on the second map, the injection start timing SOI is set to be retarded from a specified timing that is used when the engine speed NE is equal to the specified engine speed. This structure also prevents atomized fuel from being carried toward the spark plug 25 by an airflow generated in the combustion chamber 23 in the intake stroke in the same manner as in the above embodiments. In other words, this reduces decreases in the temperature of the spark plug 25 that results from the vaporization of the atomized fuel in the periphery of the spark plug 25.

In the first, third, and fourth embodiments, if the engine speed NE is higher than the specified engine speed, the injection start timing SOI is set to be further retarded as the engine speed NE increases. As a mode for setting the injection start timing SOI, the injection start timing SOI may be set to be retarded in stages in accordance with a change to increase the engine speed NE.

In the first and second embodiments, if the engine speed NE is lower than the specified engine speed, the injection start timing SOI may be set to advance in stages in accordance with a change for an increase in the engine speed NE. In the same manner, in the fourth embodiment, if the engine speed NE is lower than the specified engine speed, the injection start timing SOI may be set to be retarded in stages in accordance with increasing changes of the engine speed NE.

In the above embodiments, the first to fourth specified engine speeds NEP1 to NEP4 may be the same value or different values.

In the fourth embodiment, the ratio of the amount of change of the injection start timing SOI to the amount of change per unit in the engine speed NE when the engine speed NE is lower than the fourth specified engine speed NEP4 is the same as the ratio of the amount of change of the injection start timing SOI to the amount of change per unit in the engine speed NE when the engine speed NE is higher than or equal to the fourth specified engine speed NEP4. However, the structure by which the injection start timing SOI is retarded as the engine speed NE increases in any values in the engine speed NE is not limited in such a manner. For example, the ratio of the amount of change of the injection start timing SOI to the amount of change per unit in the engine speed NE when the engine speed NE is lower than the fourth specified engine speed NEP4 may be differ from the ratio of the amount of change of the injection start timing SOI to the amount of change per unit in the engine speed NE when the engine speed NE is higher than or equal to the fourth specified engine speed NEP4.

The setting of the injection start timing SOI in the above embodiments provides the advantage of limiting decreases in the temperature of the spark plug 25 as long as at least the period in which the fuel injection rate is the maximum value does not overlap with the period in which the movement speed of the piston 26 becomes the maximum in the intake stroke. Thus, in the above embodiments, a period from the injection start timing SOI in which injection starts until the fuel injection rate reaches the maximum value may overlap with the period in which the movement speed of the piston 26 reaches the maximum. The injection start timing SOI may be set to be further retarded from the period in which the movement speed of the piston 26 reaches the maximum.

In the above embodiments, the controller 10 is not limited to one that includes a CPU and a ROM and executes software processing. For example, the controller 10 may include a dedicated hardware circuit (such as ASIC) that executes hardware processing on at least a part of software processed data in the above embodiments. In other words, the controller 10 may include any one of the following structures of (a) to (c). (a) A controller including a processor that executes all the above processing in accordance with a program and a program storage such as a ROM that stores the program. (b) A controller including a processor and a program storage that execute a part of the above processing in accordance with a program, and a hardware circuit that executes remaining processing. (c) A controller including a dedicated hardware circuit that executes all the above processing. A software processing circuit that includes the processor and the program storage, and the dedicated hardware circuit may be single or plural. In other words, the above processing may be executed by processing circuitry that includes at least either one or plural software processing circuits or one or plural dedicated hardware circuits.

Therefore, the present examples and embodiments are to be considered as illustrative and not restrictive and the disclosure is not to be limited to the examples and embodiments given herein.

1. A controller configured to control an internal combustion engine, wherein the internal combustion engine includes a cylinder injection valve and a spark plug arranged at a central portion of a combustion chamber wall, which is one of combustion chamber walls defining a combustion chamber and which is provided on a cylinder head, the controller comprising:
an injection control unit configured to set an injection start timing of fuel based on an engine speed to start injecting the fuel with the cylinder injection valve during an intake stroke, wherein
the injection start timing set by the injection control unit when the engine speed is equal to a specified engine speed is referred to as a specified timing, and
the injection control unit is configured to set the specified timing as the injection start timing or retard the injection start timing from the specified timing when the engine speed is higher than the specified engine speed.

2. The internal combustion engine controller according to claim 1, wherein the injection control unit is configured to set the injection start timing to be further retarded as the engine speed increases when the engine speed is higher than the specified engine speed.

3. The internal combustion engine controller according to claim 1, wherein the injection control unit is configured to set the specified timing as the injection start timing when the engine speed is higher than the specified engine speed.

4. The internal combustion engine controller according to claim 1 wherein the injection control unit is configured to set the injection start timing to be further advanced until the specified timing as the engine speed increases when the engine speed is lower than the specified engine speed.

5. The internal combustion engine controller according to claim 2, wherein the injection control unit is configured to set the specified timing as the injection start timing when the engine speed is lower than the specified engine speed.

6. The internal combustion engine controller according to claim 1, wherein the injection control unit is configured to set an injection end timing based on the injection start timing and a fuel injection amount.

7. The internal combustion engine controller according to claim 1, wherein
the controller is applied to an internal combustion engine that uses alcohol-blended fuel, and
the injection control unit is configured to set the injection start timing to be further retarded as alcohol concentration in injected fuel increases.
